(19) United States
(12) Patent Application Publication
(10) Pub. No.: US 2011/0148972 A1
(43) Pub. Date: Jun. 23, 2011

(54) RECORDING APPARATUS AND RECORDING METHOD

(75) Inventor: Kazuhiro Hara, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/969,765

(22) Filed: Dec. 16, 2010

Related U.S. Application Data
(60) Provisional application No. 61/288,454, filed on Dec. 21, 2009.

(51) Int. Cl. B41J 29/38

(52) U.S. Cl. 347/16

(57) ABSTRACT

According to an embodiment, a recording apparatus includes at least one line-type recording head, a circulation path, and plural roller pairs. The recording head performs multi-pass image formation. The circulation path includes a first path facing the recording head, and a second path to connect a first end side to a second end side of the first path. The plural roller pairs exist in the second path.

### CROSS-REFERENCE TO RELATED APPLICATIONS

This application is based upon and claims the benefit of priority from Provisional Application No. 61/288,454, filed on Dec. 21, 2009, the entire contents of which are incorporated herein by reference.

### FIELD

Embodiments described herein relate generally to a multi-pass recording apparatus.

### BACKGROUND

Hitherto, there is an inkjet recording apparatus in which a sheet is wound around a drum and is rotated plural times, and a line head is used to perform multi-pass printing on the sheet.

However, in the inkjet recording apparatus for performing the multi-pass printing, since the sheet is wound around the drum, the sheet longer than the outer peripheral length of the drum can not be used.

### BRIEF DESCRIPTION OF THE DRAWINGS

FIG. 1 is an exemplary lateral sectional view of an inkjet recording apparatus of an embodiment.

FIG. 2 is an exemplary lateral sectional view in which a part of the inkjet recording apparatus of the embodiment is enlarged.

FIG. 3 is an exemplary block diagram of a control system of the inkjet recording apparatus of the embodiment.

FIG. 4 is an exemplary flowchart for explaining a print operation of the inkjet recording apparatus of the embodiment.

FIG. 5 is an exemplary view for explaining sheet circulation in a multi-pass system in the embodiment.

FIG. 6 is an exemplary view for explaining sheet reversal in the embodiment.

### DETAILED DESCRIPTION

In general, according to one embodiment, a recording apparatus includes at least one line-type recording head, a circulation path, and plural roller pairs. The recording head performs multi-pass image formation. The circulation path includes a first path facing the recording head and a second path to connect a first end side to a second end side of the first path. The plural roller pairs exist in the second path.

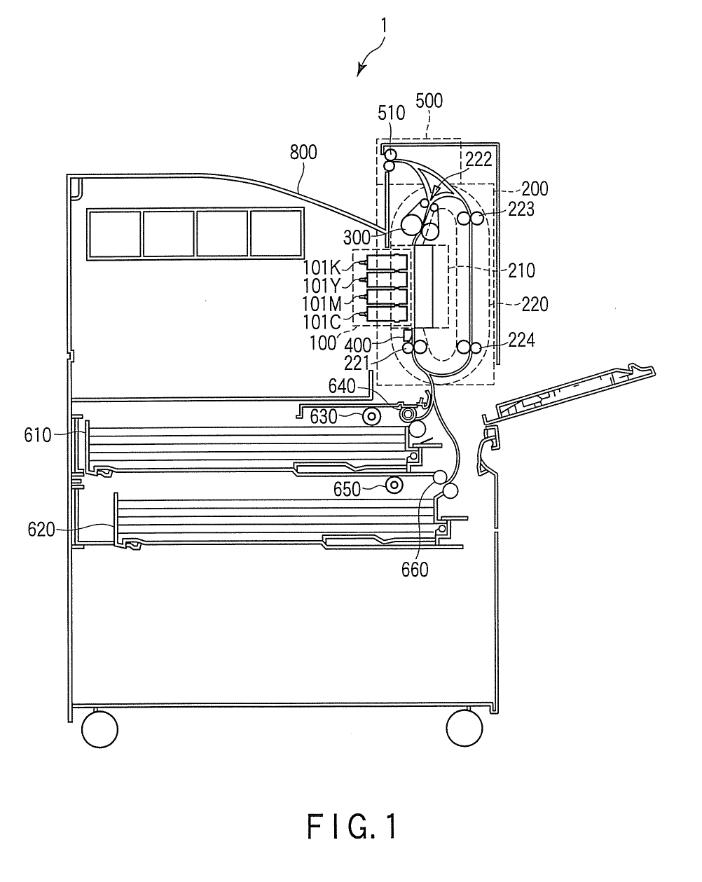

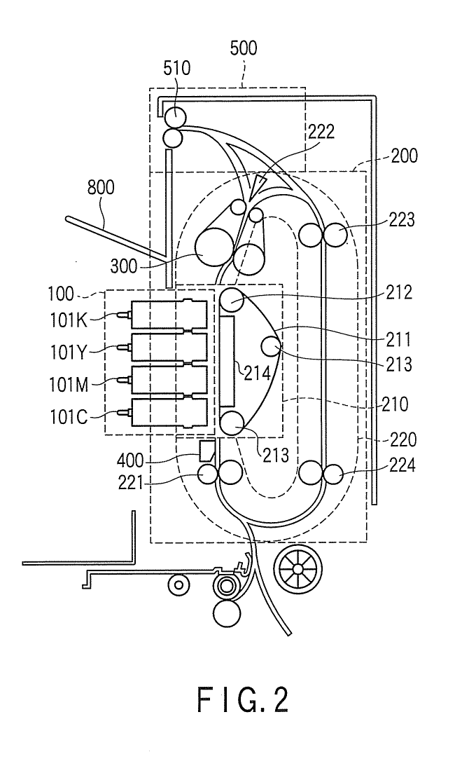

Hereinafter, embodiments will be described with reference to the drawings. FIG. 1 is a lateral sectional view of an inkjet recording apparatus 1 of an embodiment. The inkjet recording apparatus 1 includes an image forming unit 100, a circulation unit (circulation path) 200, a drying unit 300, a sensor 400, a paper discharge unit 500, a first sheet cassette 610 and a second sheet cassette 620. FIG. 2 is a lateral sectional view of the inkjet recording apparatus 1, in which the vicinities of the image forming unit 100, the circulation unit 200, the drying unit 300, the sensor 400 and the paper discharge unit 500 are enlarged and shown in detail.

The image forming unit 100 includes an inkjet recording head 101C, an inkjet recording head 101M, an inkjet recording head 101Y and an inkjet recording head 101K in sequence from an upstream side in a conveyance direction of a sheet (recording medium). The inkjet recording heads 101C, 101M, 101Y and 101K are arranged in a vertical direction. Here, it is assumed that the resolution of each of the inkjet recording heads 101C, 101M, 101Y and 101K is 150 dpi. The image forming unit 100 is arranged to face a facing portion 210 of the circulation unit 200. The inkjet recording head 101C ejects cyan ink. The inkjet recording head 101M ejects magenta ink. The inkjet recording head 101Y ejects yellow ink. The inkjet recording head 101K ejects black ink.

Each of the inkjet recording heads 101C, 101M, 101Y and 101K is a line-type head in which nozzles to eject ink droplets are arranged at a specified resolution in a direction (sheet width direction) orthogonal to the sheet conveyance direction. The inkjet recording heads 101C, 101M, 101Y and 101K form a color image at a desired position of a sheet surface.

The circulation unit 200 includes the facing portion (first path) 210 and a non-facing portion (second path) 220. The circulation unit 200 is a circularly formed sheet conveyance path in which one end side (first end side) of the facing portion 210 is continuous with one end side (first end side) of the non-facing portion 220, and the other end side (second end side) of the facing portion 210 is continuous with the other end side (second end side) of the non-facing portion 220. The circulation unit 200 is used if two-sided printing is performed or one side is printed in a multi-pass mode. In FIG. 1, the sheet is conveyed clockwise in the circulation unit 200. The facing portion 210 is a portion facing the image forming unit 100. The non-facing portion 220 is a remaining portion obtained by removing the facing portion 210 from the circulation unit 200. The facing portion 210 includes a conveyance belt 211, a drive roller 212, a driven roller 213 and a negative pressure chamber 214. The conveyance belt 211 is endlessly extended over the drive roller 212 and the driven roller 213. The conveyance belt 211 operates in accordance with the rotation of the drive roller 212. Holes are formed in the surface of the conveyance belt 211 at specified intervals. The negative pressure chamber 214 connected to a not-shown fan is installed inside the conveyance belt 211 in order to cause a medium to be absorbed to the conveyance belt 211. The facing portion 210 is a sheet conveyance path in the vertical direction.

The non-facing portion 220 includes a register roller pair 221, a flapper 222, a roller pair 223 and a roller pair 224. The register roller pair 221 is provided upstream of the facing portion 210 in the sheet conveyance direction. The flapper 222 is provided downstream of the drying unit 300 in the sheet conveyance direction. The flapper 222 is switched to either one of a position where the sheet passing through the facing portion 210 is conveyed to the roller pair 223 side and a position where the sheet is conveyed to the paper discharge unit 500 side. That is, the sheet conveyance path branches at the one end side of the non-facing portion 220. The non-facing portion 220 includes a conveyance path in the vertical direction, which is parallel to the facing portion 210. The roller pair 223 and roller pair 224 are provided in the vertical direction from the one end side to the other end side of the non-facing portion 220. Incidentally, the number of roller pairs of the non-facing portion 220 is not limited to two, and no limitation is made to the roller pair 223 and the roller pair 224.

The drying unit 300 is arranged downstream of the image forming unit 100 in the sheet conveyance direction. The drying unit 300 dries the surface of the sheet after image formation by the image forming unit 100 is completed. The sensor 400 is provided in the circulation unit 200. The sensor 400 is positioned downstream of the register roller pair 221 in the sheet conveyance direction and upstream of the facing portion 210. The sensor 400 is a contact image sensor. The sensor 400 detects a position of a register mark printed on the sheet by the image forming unit 100 and detects a lateral shift amount which is a shift of the sheet in the width direction from a normal position.

The paper discharge unit 500 is positioned above the circulation unit 200. The paper discharge unit 500 includes a paper discharge roller pair 510. The paper discharge unit 500 includes a path which is branched from the circulation unit 200 by the flapper 222 and extends to the paper discharge roller pair 510, and a path extending from the paper discharge roller pair 510 side to the roller pair 223 side. That is, the paper discharge unit 500 includes the two paths between itself and the circulation unit 200. A paper discharge tray 800 is provided on an upper part of an outer surface of the inkjet recording apparatus 1. The paper discharge tray 800 sequentially contains sheets, which are discharged from the paper discharge roller pair 510 and on one side or both sides of which an image is formed, in a pile.

The first sheet cassette 610 and the second sheet cassette 620 are provided below the circulation unit 200 in the inkjet recording apparatus 1. The first sheet cassette 610 contains a sheet bundle including plural sheets. The second sheet cassette 620 contains a sheet bundle including plural sheets different in size from the sheets contained in the first sheet cassette 610.

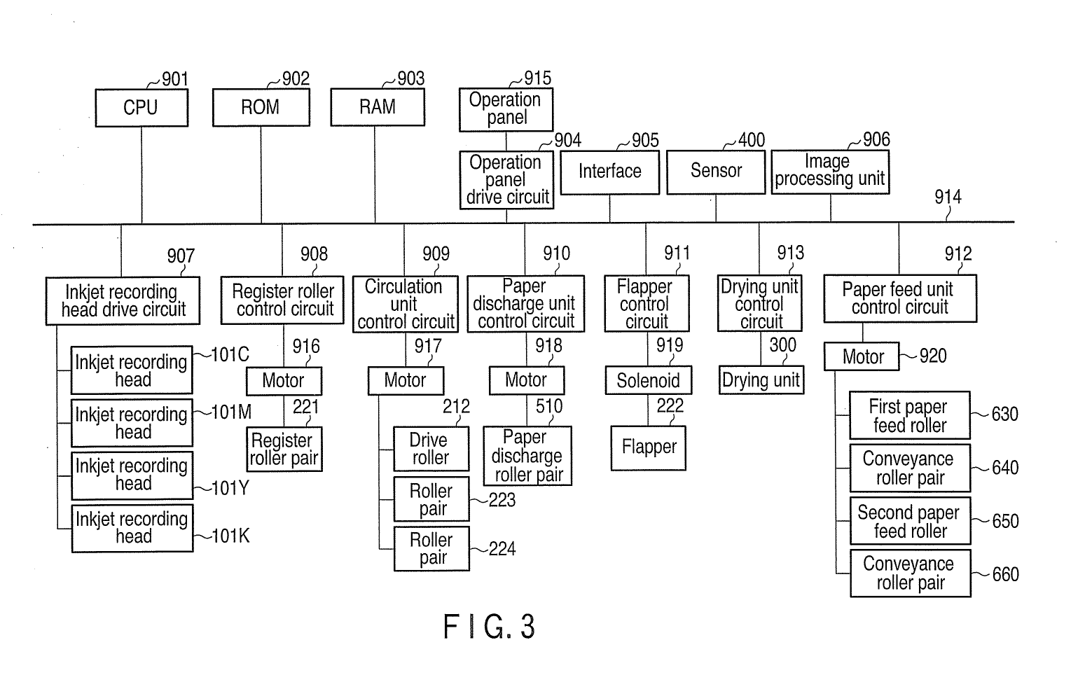

FIG. 3 is a block diagram showing a control system of the inkjet recording apparatus 1 of the embodiment. The inkjet recording apparatus 1 includes a CPU 901, a ROM 902, a RAM 903, an operation panel drive circuit 904, an interface 905, an image processing unit 906, an inkjet recording head drive circuit 907, a register roller control circuit 908, a circulation unit control circuit 909, a paper discharge unit control circuit 910, a flapper control circuit 911, a paper feed unit control circuit 912, and a drying unit control circuit 913. The above respective components are connected through a CPU bus 914.

The CPU 901 is a microprocessor and executes various arithmetic processings. The CPU 901 controls the operations of the respective units connected through the CPU bus 914. The ROM 902 is a program memory and stores various programs executed by the CPU 901. The RAM 903 is a working memory and temporarily stores data. The operation panel drive circuit 904 processes the input from the operation panel 915. The operation panel 915 can input various operations to the inkjet recording apparatus 1. The interface 905 connects an external computer to the CPU bus 914. The interface 905 inputs a print request and an image signal to the inkjet recording apparatus 1 from the external computer. The image processing unit 906 executes an image processing on the inputted image signal. Thereafter, the image processing unit 906 converts the image signal into print data suitable for printing by the inkjet recording heads 101C, 101M, 101Y and 101K.

The inkjet recording head drive circuit 907 controls ejection of ink from the inkjet recording heads 101C, 101M, 101Y and 101K based on the print data under control of the CPU 901. Further, if multi-pass printing is performed, the inkjet recording head drive circuit 907 controls the movement of the inkjet recording heads 101C, 101M, 101Y and 101K in the sheet width direction. The register roller control circuit 908 drives and controls a motor 916 under control of the CPU 901. The motor 916 drives the register roller pair 221 to convey the sheet to the facing portion 210. The circulation unit control circuit 909 drives and controls a motor 917 under control of the CPU 901. The motor 917 independently drives the drive roller 212, the roller pair 223 and the roller pair 224. The motor 917 drives the drive roller 212 in the facing portion 210 so as to convey the sheet in the direction of circulating in the circulation unit 200. The motor 917 drives the roller pairs 223 and 224 in the non-facing portion 220 so as to convey the sheet in the direction of circulating in the circulation unit 200. The paper discharge unit control circuit 910 drives and controls a motor 918 under control of the CPU 901. The motor 918 drives the paper discharge roller pair 510. The motor 918 can drive the paper discharge roller pair 510 to convey the sheet in both directions. The flapper control circuit 911 drives and controls a solenoid 919 under control of the CPU 901. The solenoid 919 drives the flapper 222. The paper feed unit control circuit 912 drives and controls a motor 920 under control of the CPU 901. The motor 920 independently drives a first paper feed roller 630, a conveyance roller pair 640, a second paper feed roller 650 and a conveyance roller pair 660. If the sheet is conveyed from the first sheet cassette 610 to the register roller pair 221, the motor 920 drives the first paper feed roller 630 so that the sheet is taken out one by one from the uppermost sheet of the sheet bundle contained in the first sheet cassette 610, and is conveyed to the conveyance roller pair 640. Thereafter, the motor 920 drives the conveyance roller pair 640 to convey the sheet to the register roller pair 221. Similarly, if the sheet is conveyed from the second sheet cassette 620 to the register roller pair 221, the motor 920 drives the second paper feed roller 650 so that the sheet is taken out one by one from the uppermost sheet of the sheet bundle contained in the second sheet cassette 620 and is conveyed to the conveyance roller pair 660. Thereafter, the motor 920 drives the conveyance roller pair 660 to convey the sheet to the register roller pair 221. The drying unit control circuit 913 drives and controls the drying unit 300 under control of the CPU 901.

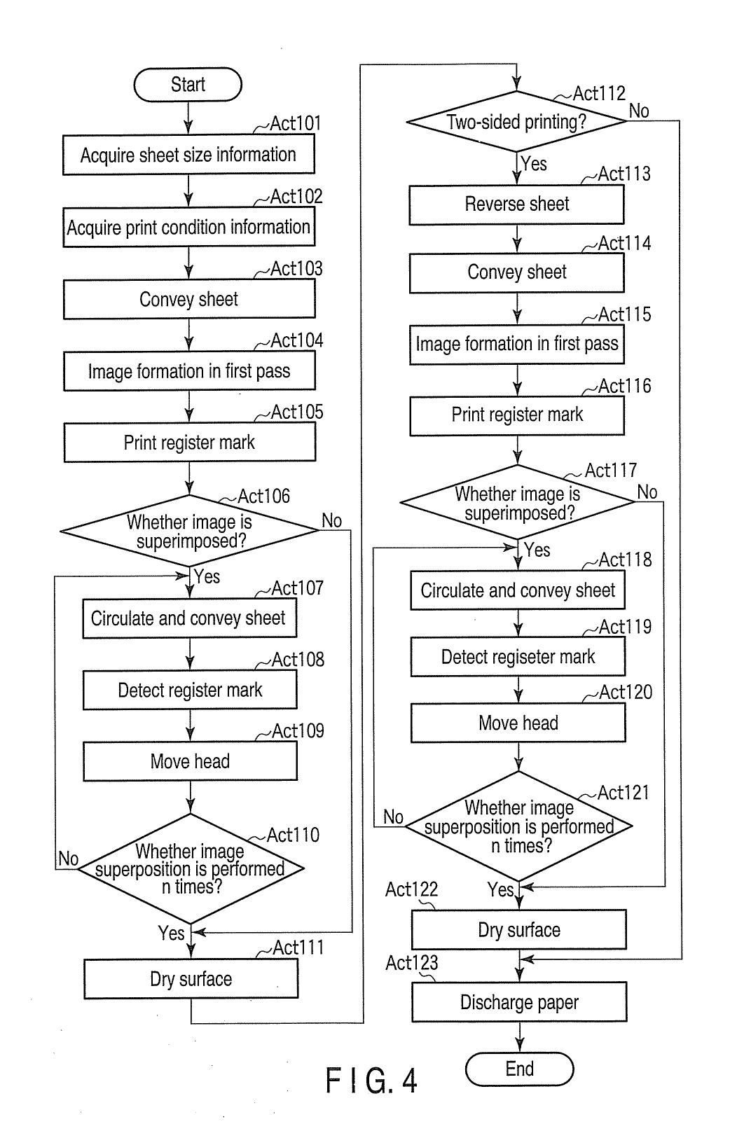

FIG. 4 is a flowchart for explaining a print operation of the inkjet recording apparatus 1. First, the CPU 901 acquires sheet size information of a print object based on a print request inputted from the external computer (Act 101). The CPU 901 acquires print condition information based on the print request inputted from the external computer (Act 102). The print condition information includes resolution information (information indicating one-path printing or multi-pass printing), information indicating color printing or monochrome printing, and information indicating one-sided printing or two-sided printing.

The CPU 901 controls so that the sheet of the size based on the print request is conveyed from the first sheet cassette 610 or the second sheet cassette 620 to the register roller pair 221. If the sheet is conveyed from the first sheet cassette 610 to the register roller pair 221, the CPU 901 controls so that the first paper feed roller 630 and the conveyance roller pair 640 convey the sheet to the register roller pair 221. Similarly, if the sheet is conveyed from the second sheet cassette 620 to the register roller pair 221, the CPU 901 controls so that the second paper feed roller 650 and the conveyance roller pair 660 convey the sheet to the register roller pair 221.

The CPU 901 controls so that the register roller pair 221 conveys the sheet of the size based on the print request to the facing portion 210 (Act 103). Incidentally, the CPU 901 may control so that before the register roller pair 221 supplies the sheet to the facing portion 210, the conveyance is temporarily stopped and aligning of the front end of the sheet is performed. At this time, the CPU 901 controls so that the register roller pair 221 again starts to convey the sheet and supplies it to the facing portion 210. The CPU 901 controls so that the sheet is conveyed in the facing portion 210 from the upstream side where the inkjet recording head 101C is provided to the downstream side where the inkjet recording head 101K is provided.

The CPU 901 controls so that the image forming unit 100 performs image formation in the first pass on the surface of the sheet based on the print data processed by the image processing unit 906 (Act 104). Further, the CPU 901 controls so that the image forming unit 100 prints a register mark on an edge of the sheet (Act 105). Incidentally, the CPU 901 controls so that the image forming unit 100 uses yellow ink to print the resist mark on the sheet. This is because the yellow ink is hardly visually recognized even if it is printed on the sheet.

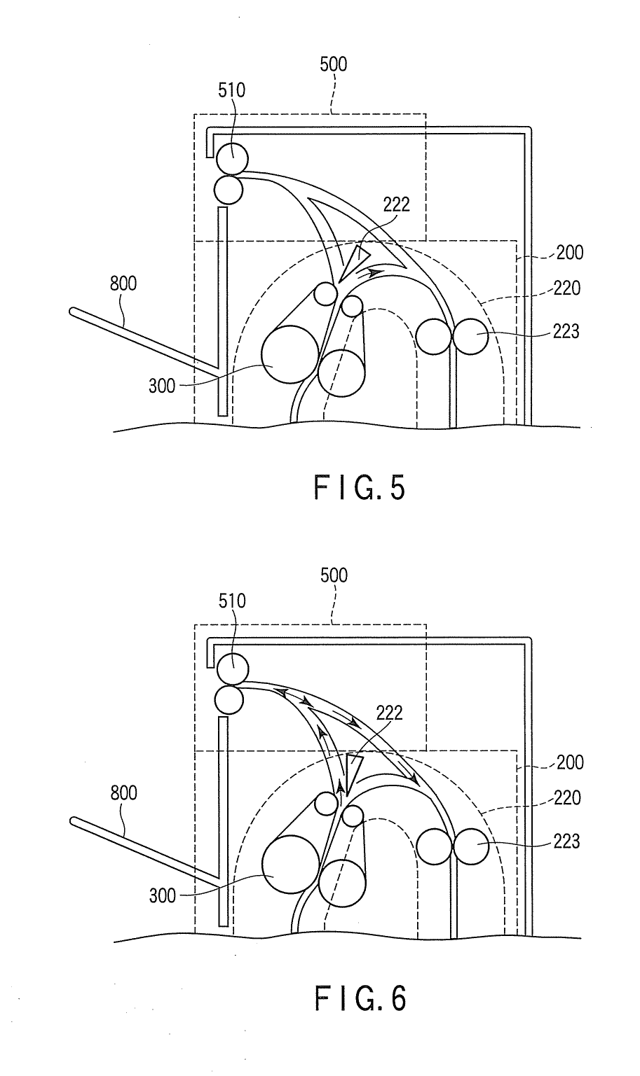

The CPU 901 determines, based on the print condition information, whether multi-pass printing is requested in which image formation is overlappingly performed on the same surface plural times (n times, n is two or more) (Act 106). If the multi-pass printing is requested (Act 106, Yes), the CPU 901 controls so that the sheet subjected to the image formation in the first pass is circulated and conveyed in the circulation unit 200 to the upstream side of the register roller pair 221 (Act 107). At this time, the CPU 901 controls so that the position of the flapper 222 is changed so as to circulate the sheet in the circulation unit 200. The CPU 901 controls so that the roller pairs 223 and 224 supply the sheet to the register roller pair 221. FIG. 5 is a view in which a path of a sheet conveyed in the circulation unit 200 is indicated by an arrow. The CPU 901 controls so that the register roller pair 221 again supplies the sheet to the facing portion 210. That is, the surface of the sheet on the facing portion 210 is the surface which is already once subjected to the image formation by the image forming unit 100.

The CPU 901 controls so that the sensor 400 detects the register mark printed on the sheet in the first pass before the sheet is supplied to the facing portion 210 (Act 108). The sensor 400 detects the lateral shift amount of the sheet based on the detection of the register mark. The CPU 901 controls so that the respective positions of the inkjet recording heads 101C, 101M, 101Y and 101K are moved by one dot (about 42.3 μm) in the sheet width direction (Act 109). Incidentally, the CPU 901 may control so that the respective positions of the inkjet recording heads 101C, 101M, 101Y and 101K are further moved to cancel the lateral shift amount of the sheet. This is because for example, the roller pairs 223 and 224 of the circulation unit 200 have an error in cylindricality. The sheet is laterally shifted in the sheet width direction from the normal position in the conveyance process by the roller pairs 223 and 224. Accordingly, in the facing portion 210, if the same sheet is conveyed plural times, the position of the sheet in the width direction is not always the same with respect to the normal position. Thus, the CPU 901 controls so that the inkjet recording heads 101C, 101M, 101Y and 101K are moved by the amount in view of also the lateral shift amount of the sheet.

Thereafter, the CPU 901 controls so that the second image formation is performed on the surface of the sheet by the image forming unit 100. The CPU 901 determines whether the nth image formation based on the print condition information is finished (Act 110).

For example, if a print request of performing image formation on a sheet at 600 dpi is inputted from the external computer to the inkjet recording apparatus 1, the CPU 901 controls so that the sheet is supplied four times in total by the register roller pair 221 to the facing portion 210. That is, the CPU 901 controls so that the image formation is performed n=4 times on the sheet at 150 dpi while the inkjet recording heads 101C, 101M, 101Y and 101K are shifted by one dot in the sheet width direction each time the sheet is supplied to the facing portion 210. That is, the CPU 901 controls so that the sheet is circulated in the circulation unit 200, and consequently, the image formation is performed on the surface of the sheet at a desired resolution (150 dpi×4=600 dpi).

If the nth image formation is not finished (Act 110, NO), return is made to Act 107, and the CPU 901 controls so that the sheet subjected to the mth image formation (m is two or more and less than n) in the circulation unit 200 is circulated and conveyed to the upstream side of the register roller pair 221. If the nth image formation is finished (Act 110, YES), the CPU 901 drives and controls the drying unit 300 so as to dry the surface of the sheet subjected to the image formation (Act 111). The same applies to the case where the multi-pass printing is not required for the first surface (If one-pass printing is requested) (Act 106, NO).

Next, the CPU 901 determines whether two-sided printing is requested based on the print condition information (Act 112). If the two-sided printing is requested (Act 112, YES), the CPU 901 controls so that the sheet is reversed from obverse to reverse (Act 113). Specifically, the CPU 901 controls as follows. The CPU 901 controls so that the sheet one side of which is subjected to image formation is conveyed to the paper discharge unit 500 from the circulation unit 200. At this time, the CPU 901 controls so that the position of the flapper 222 is changed so as to convey the sheet to the paper discharge unit 500 side. The CPU 901 controls so that the paper discharge roller pair 510 discharges the sheet to the paper discharge tray 800 side until the trailing end of the sheet comes to have a specified length. Thereafter, the CPU 901 controls so that the paper discharge roller pair (reverse unit) 510 conveys (switches back) the sheet in the reverse direction to the discharge direction. The CPU 901 controls so that the sheet is conveyed from the paper discharge roller pair 510 to the roller pair 223. FIG. 6 is a view showing the path of the sheet switched back by the paper discharge roller pair 510, which is indicated by an arrow. The CPU 901 controls so that the roller pairs 223 and 224 convey the sheet to the upstream side of the register roller pair 221. The CPU 901 controls so that the register roller pair 221 conveys the sheet to the facing portion 210 (Act 114). That is, the surface facing the image forming unit 100 is the surface opposite to the surface which was already subjected to the image formation by the image forming unit 100. After this, the operations from Act 115 to Act 122 are the same as those from Act 104 to Act 111.

If the two-sided printing is not requested (Act 112, NO), or after the drying unit 300 dries the surface of the sheet at Act 122, the CPU 901 controls so that the sheet is conveyed from the circulation unit 200 to the paper discharge unit 500. At this time, the CPU 901 controls so that the position of the flapper 222 is changed so as to convey the sheet to the paper discharge unit 500 side. Thereafter, the CPU 901 controls so that the paper discharge roller pair 510 discharges the sheet supplied from the circulation unit 200 to the paper discharge tray 800 (Act 123).

Incidentally, at Act 109, although the CPU 901 controls so that the respective positions of the inkjet recording heads 101C, 101M, 101Y and 101K are further moved by the amount of canceling the lateral shift amount of the sheet, no limitation is made to this. For example, the CPU 901 may control, through the register roller control circuit 908, so that the register roller pair 221 moves the sheet in the width direction by the amount of canceling the lateral shift amount.

Incidentally, in this embodiment, although the image forming unit 100 includes the inkjet recording heads 101C, 101M and 101Y for color printing, the image forming unit 100 may include only the inkjet recording head 101K for monochrome printing. Besides, in this embodiment, although the description is made on the example in which the image forming unit 100 performs printing in the inkjet system, the image forming unit 100 may perform printing by a thermal head.

Besides, in this embodiment, the circulation unit 200 includes the path corresponding to plural sheet sizes in the longitudinal direction. Further, the circulation unit 200 has the outer periphery longer than the maximum length of the first sheet cassette 610 or the second sheet cassette 620 in the longitudinal direction (that is, the length of the maximum size sheet in the longitudinal direction, which can be contained in the inkjet recording apparatus 1). This is because if the first sheet cassette 610 or the second sheet cassette 620 can contain the sheet of the size longer than the outer periphery of the circulation unit 200, this sheet can not be circulated in the circulation unit 200.

According to this embodiment, by the simple structure using the circular circulation unit 200 for two-sided printing, high quality multi-pass printing at a desired resolution can be realized without limitation of the basis weight of the sheet and the size of the sheet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording apparatus comprising:
at least one line-type recording head which performs multi-pass image formation;
a circulation path which includes a first path facing the recording head, and a second path to connect a first end side to a second end side of the first path; and
a plurality of roller pairs which exists in the second path.

2. The apparatus of claim 1, comprising a controller which controls to circulate a sheet a plurality of times in the circulation path.

3. The apparatus of claim 2, comprising a sensor which detects a lateral shift amount, in a width direction orthogonal to a conveyance direction, of the sheet conveyed in the circulation path.

4. The apparatus of claim 3, wherein the sensor is positioned upstream of the recording head in the conveyance direction of the sheet.

5. The apparatus of claim 3, wherein the controller moves the recording head in the width direction each time the sheet is circulated to a position where the sheet faces the recording head.

6. The apparatus of claim 5, wherein the controller moves the recording head in the width direction to cancel the lateral shift amount each time the sheet is circulated to the position where the sheet faces the recording head.

7. The apparatus of claim 3, wherein the recording head prints a register mark on the sheet.

8. The apparatus of claim 7, wherein the sensor detects the lateral shift amount based on detection of a position of the register mark.

9. The apparatus of claim 8, wherein the recording head prints the register mark on the sheet in a first pass.

10. The apparatus of claim 9, wherein the recording head prints the register mark of yellow on the sheet.

11. The apparatus of claim 2, wherein the circulation path has a path length longer than a length of a maximum size sheet in a longitudinal direction, which can be contained in the recording apparatus.

12. The apparatus of claim 2, wherein the controller controls to circulate the sheet reversed in the circulation path.

13. A recording method used in a recording apparatus comprising at least one line-type recording head which performs multi-pass image formation, and a circulation path which includes a first path facing the recording head and a second path to connect a first end side to a second end side of the first path, the method comprising:
receiving a print request; and
circulating a sheet in the circulation path a plurality of times.

14. The method of claim 13, comprising detecting a lateral shift amount, in a width direction orthogonal to a conveyance direction, of the sheet conveyed in the circulation path.

15. The method of claim 14, comprising detecting the lateral shift at an upstream side of the recording head in the conveyance direction of the sheet.

16. The method of claim 14, comprising moving the recording head in the width direction each time the sheet is circulated to a position where the sheet faces the recording head.

17. The method of claim 16, comprising moving the recording head in the width direction to cancel the lateral shift amount each time the sheet is circulated to the position where the sheet faces the recording head.

18. The method of claim 14, comprising printing a register mark on the sheet by the recording head.

19. The method of claim 18, comprising detecting the lateral shift amount based on detection of a position of the register mark.

20. The method of claim 19, comprising printing the register mark of yellow on the sheet by the recording head.
